(19) United States
(12) Patent Application Publication
(10) Pub. No.: US 2018/0024709 A1
(43) Pub. Date: Jan. 25, 2018

(54) SOCIAL MEDIA RADIO

(71) Applicant: Panasonic Automotive Systems Company of America, Division of Panasonic Corporation of North America, Peachtree City, GA (US)

(72) Inventors: Sachiko KOBAYASHI, Novi, MI (US); Patrick HANSLITS, Clarkston, MI (US); Donald Allen TURNER, Livonia, MI (US); David LYON, Huntington Woods, MI (US); Gary L. BRADDOCK, Grosse Pointe, MI (US); Narayani MITAL, Royal Oak, MI (US)

(73) Assignee: Panasonic Automotive Systems Company of America, Division of Panasonic Corporation of North America

(21) Appl. No.: 15/655,141

(22) Filed: Jul. 20, 2017

Related U.S. Application Data
(60) Provisional application No. 62/364,795, filed on Jul. 20, 2016.

(51) Int. Cl. G06F 3/0482; G06F 3/0488; G06F 3/0481; G06Q 50/00; G06F 3/16

(52) U.S. Cl. CPC G06F 3/0482; G06Q 50/01; G06F 3/167; G06F 3/04817; G06F 3/0488

(57) ABSTRACT

A motor vehicle infotainment system includes a user interface having a loudspeaker. The user interface receives a request from a driver to access a social media web site. An electronic processor accesses postings on the social media web site, and discerns first ones of the postings having primarily graphic aspects from second ones of the postings not having primarily graphic aspects. Only the ones of the postings not having primarily graphic aspects are presented to the driver via the loudspeaker.

### CROSS-REFERENCED TO RELATED APPLICATIONS

This application claims benefit of U.S. Provisional Application No. 62/364,795 filed on Jul. 20, 2016, which the disclosure of which is hereby incorporated by reference in its entirety for all purposes.

### FIELD OF THE INVENTION

The disclosure relates to the field of automotive infotainment systems, and, more particularly, to enabling a driver to access social media while driving a motor vehicle.

### BACKGROUND OF THE INVENTION

Social media has become an important part of people's lives, and many people want to be connected to friends and family even while they drive. However, social media is a primary reason why drivers become distracted from their driving task. It is not possible for a driver to safely interact with social media on smartphones and other handheld devices while driving. Currently, there is no safe way to enable a driver to engage social media while driving a vehicle.

### SUMMARY

The present invention may provide a safe way for a driver to experience social media and be “connected” in-vehicle via a virtual “radio station”. This virtual radio station may aggregate the driver's social media favorites and enable the driver to interact with the social media safely just as he would with any other talk shows, XM radio stations, and podcasts. The virtual radio station may audibly read posts on the driver's social media accounts (e.g., Facebook, Twitter, etc.) so that he can listen to the spoken posts while driving. However, the virtual radio station may ignore any posts focused on visual or graphic features, such as posts that refer to a visual image. The driver may be able to perform basic and limited functions while driving, such as “liking” a post, making voice-based posts/comments, toggling comments ON/OFF, and tagging posts that he wants to read or see later when the car is in park mode. The driver may be able to perform some of these basic and limited functions via steering wheel controls while driving. The virtual radio station contents may be filtered, and the interface may be simple/safe so as to be National Highway Traffic Safety Administration (NHTSA) compliant. Thus, the invention may safely provide drivers with what they want.

In one embodiment, the invention comprises a motor vehicle infotainment system including a user interface having a loudspeaker. The user interface receives a request from a driver to access a social media web site. An electronic processor accesses postings on the social media web site, and discerns first ones of the postings having graphic aspects and no visual distractions from second ones of the postings not having graphic aspects. Only the ones of the postings not having graphic aspects are presented to the driver via the loudspeaker.

In another embodiment, the invention comprises a method of operating a motor vehicle infotainment system, including installing in the vehicle a user interface including a loudspeaker. The user interface is used to receive a request from a driver to access a social media web site. An electronic processor is installed in the vehicle, and is used to access posts on the social media web site; discern first ones of the posts having graphic aspects from second ones of the posts not having graphic aspects; and present only the ones of the posts not having graphic aspects to the driver via the loudspeaker.

In yet another embodiment, the invention comprises a motor vehicle infotainment system including a loudspeaker, a microphone, a touch-sensitive display screen, and an electronic processor. The microphone and/or the touch-sensitive display screen receive a request from a driver to access a social media web site. The infotainment system includes an electronic processor which accesses posts on the social media web site, and presents the posts to the driver exclusively via the loudspeaker.

### BRIEF DESCRIPTION OF THE DRAWINGS

A better understanding of the present invention will be had upon reference to the following description in conjunction with the accompanying drawings.

FIG. 1 is a plan view of one embodiment of a graphical user interface of a vehicle infotainment system of the present invention.

FIG. 2 is another plan view of the graphical user interface of FIG. 1 with annotations being provided in the drawing in association with some of the icons.

FIG. 3 is a block diagram of a social media arrangement of the present invention.

FIG. 4 is a flow chart of a method of the present invention for operating a motor vehicle infotainment system.

### DETAILED DESCRIPTION OF THE PREFERRED EMBODIMENTS

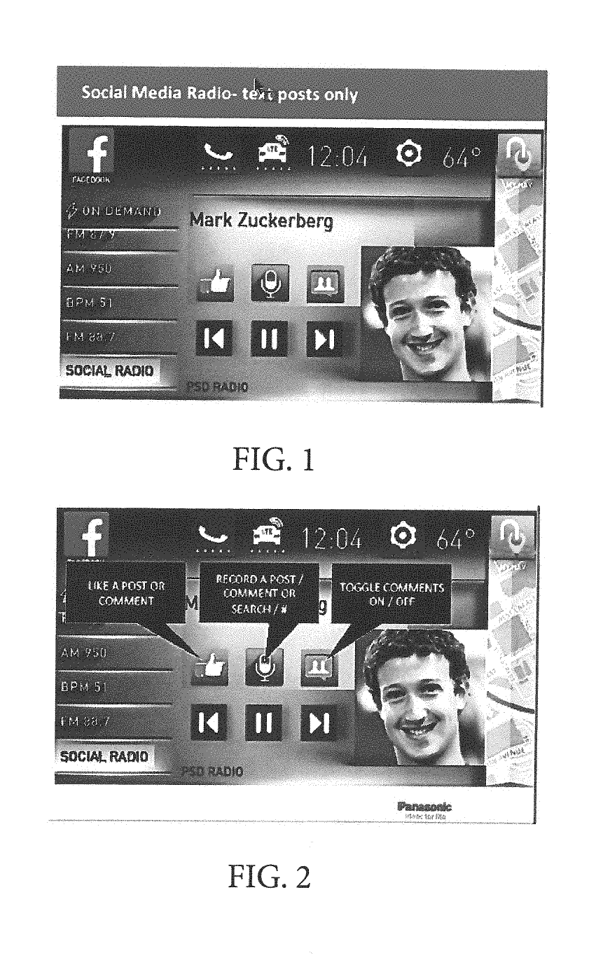

FIG. 1 illustrates one embodiment of a graphical user interface of a vehicle infotainment system of the present invention. Along the left-hand edge of the screen is a menu of radio stations accessible by the user, including a virtual social radio station option at the bottom of the screen. The virtual social radio station option has been selected and is in effect in FIG. 1. The user can interface with only text posts via the virtual social radio station, at least in the station's current mode. The driver may login to his social media account to access his account. The driver may then access his friends' accounts via voice commands. For example, the Facebook.com account of Mark Zuckerberg is currently being accessed by the virtual social radio station.

In the middle of the screen are two rows of icons selectable by the user by touching. The bottom row includes the universally recognized icons for “reverse”, “stop”, and “forward”, which the user may use to negotiate the virtual social radio station and possibly other radio stations. The top row includes three icons which may be dedicated to the virtual social radio station, and which may be associated with the functions indicated in FIG. 2. Namely, in the top row, the leftmost icon enables a user to “like” a post or comment by touching the icon. The middle icon enables a user to audibly record a post or comment, or to audibly perform a search, by touching the icon. The rightmost icon enables a user to toggle comments between ON and OFF by touching the icon. This is just one example of a graphical user interface (GUI) suitable for use with the present invention. There may be more or fewer controls on the GUI than as shown.

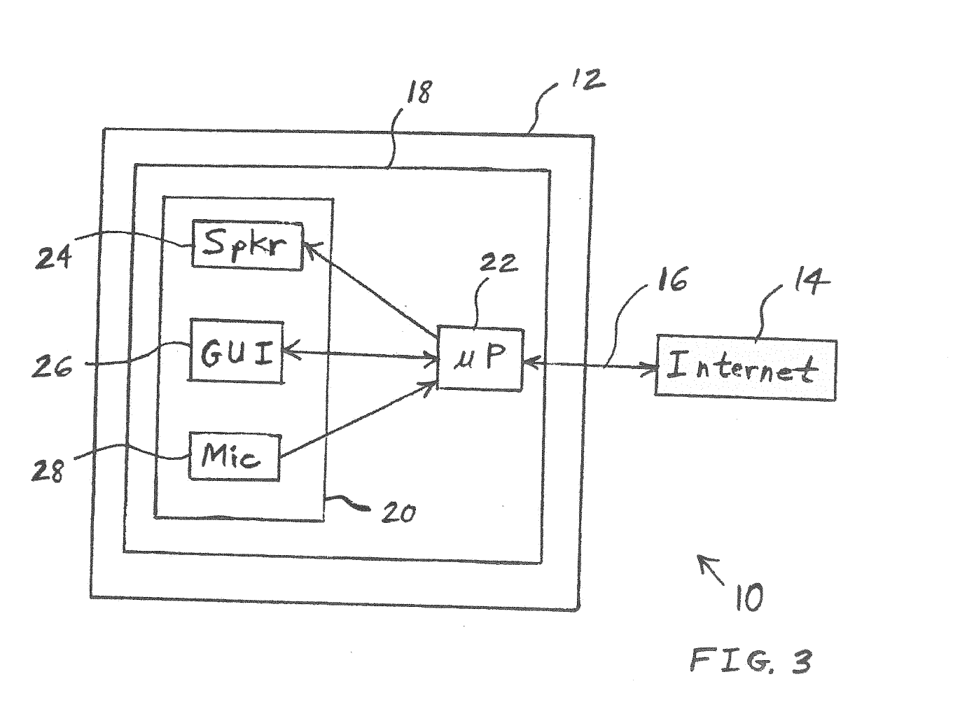

FIG. 3 illustrates a social media arrangement 10 of the present invention, including a motor vehicle 12 wirelessly connected to the Cloud, the user's social media profile, and/or the Internet 14, as indicated at 16. Vehicle 12 includes an infotainment system 18 having a user interface 20 communicatively coupled to an electronic processor 22. Processor 22 is communicatively coupled to the Internet 14. User interface 20 includes a loudspeaker 24; a graphical user interface 26 having a touch-sensitive display screen, such as those shown in FIGS. 1-2; and a microphone 28, which may be part of a voice recognition engine.

During use, user interface 20 may receive a request from a driver to access a social media web site via Internet 14. User interface 20 may receive the request from the driver via microphone 28 or the touch-sensitive screen of GUI 26. Electronic processor 22 may access postings on the social media web site via Internet 14. Electronic processor 22 may discern postings having graphic aspects from postings not having graphic aspects, and audibly present only the postings not having graphic aspects to the driver via loudspeaker 24.

A large percentage of posts on social media may have visual aspects. Accordingly, in one embodiment, processor 22 discerns posts having visuals/graphics as the primary content (e.g., personal photos) from posts having visuals/graphics as content that is supplemental to the text (e.g., news/stories).

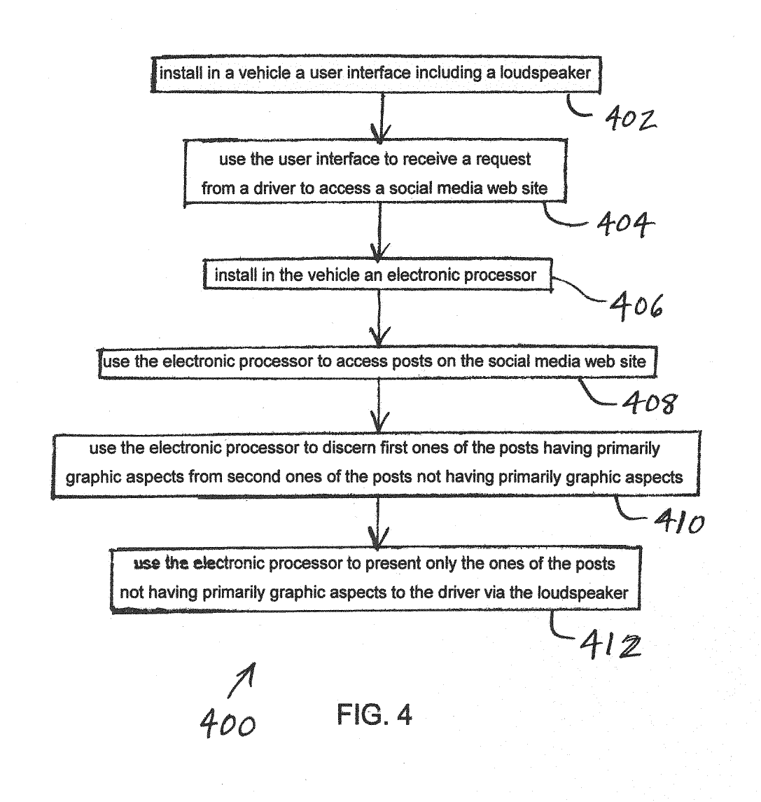

FIG. 4 illustrates a method 400 of the present invention for operating a motor vehicle infotainment system. In a first step 402, a user interface including a loudspeaker is installed in the vehicle. For example, user interface 20 including a speaker 24 may be installed in vehicle 12

Next, in step 404, the user interface is used to receive a request from a driver to access a social media web site. For example, user interface 20 may receive a request from a driver to access a social media web site via Internet 14. User interface 20 may receive the request from the driver via microphone 28 or the touch-sensitive screen of GUI 26.

In a next step 406, an electronic processor is installed in the vehicle. For example, electronic processor 22 may be installed in vehicle 12.

In step 408, the electronic processor is used to access posts on the social media web site. For example, electronic processor 22 may access postings on a social media web site via Internet 14.

Next, in step 410, first ones of the posts having primarily graphic aspects are discerned from second ones of the posts not having primarily graphic aspects. For example, processor 22 may determine whether a post has photographs, cartoons or other visual graphics and whether the post has audio recordings. By comparing the amount of data in the post that is visual to the amount of data that is audial, processor 22 may decide whether the post is primarily visual or primarily audial.

In a final step 412, only the ones of the posts not having primarily graphic aspects are presented to the driver via the loudspeaker. For example, only posts that are primarily audial may be presented to the driver via speaker 24.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle infotainment system, comprising:
a user interface including a loudspeaker, the user interface being configured to receive a request from a driver to access a social media web site; and
an electronic processor configured to:
access posts on the social media web site;
discern first ones of the posts having graphic aspects from second ones of the posts not having graphic aspects; and
present only the ones of the posts not having graphic aspects to the driver via the loudspeaker.

2. The infotainment system of claim 1 wherein the user interface includes a microphone and a touch-sensitive display screen, each of the microphone and the touch-sensitive display screen being configured to receive the request from the driver to access a social media web site.

3. The infotainment system of claim 1 wherein the user interface and the electronic processor are configured to conjointly enable the user to like selected ones of the presented posts.

4. The infotainment system of claim 1 wherein the user interface includes a microphone, the microphone and the electronic processor being configured to conjointly enable the user to create a post and/or comment on a post.

5. The infotainment system of claim 1 wherein the user interface includes a microphone and a touch-sensitive display screen, the user interface and the electronic processor being configured to conjointly enable the user to toggle post comments ON and OFF.

6. The infotainment system of claim 1 wherein the user interface includes a microphone and a touch-sensitive display screen, the user interface and the electronic processor being configured to conjointly enable the user to tag a selected post for later viewing.

7. The infotainment system of claim 1 wherein the user interface and the electronic processor are configured to conjointly enable the user to tag a selected post for later viewing on the display screen while the motor vehicle is parked.

8. A method of operating a motor vehicle infotainment system, said method comprising:
installing in the vehicle a user interface including a loudspeaker;
using the user interface to receive a request from a driver to access a social media web site;
installing in the vehicle an electronic processor; and
using the electronic processor to:
access posts on the social media web site;
discern first ones of the posts having primarily graphic aspects from second ones of the posts not having primarily graphic aspects; and
present only the ones of the posts not having primarily graphic aspects to the driver via the loudspeaker.

9. The method of claim 8 wherein the user interface includes a microphone and a touch-sensitive display screen, the method further comprising using the microphone and/or the touch-sensitive display screen to receive the request from the driver to access a social media web site.

10. The method of claim 8 further comprising using the user interface and the electronic processor to enable the user to like selected ones of the presented posts.

11. The method of claim 8 wherein the user interface includes a microphone, the method further comprising using the microphone and the electronic processor to enable the user to create a post and/or comment on a post.

12. The method of claim 8 wherein the user interface includes a microphone and a touch-sensitive display screen, the method further comprising using the user interface and the electronic processor being to enable the user to toggle post comments ON and OFF.

13. The method of claim 8 wherein the user interface includes a microphone and a touch-sensitive display screen, the method further comprising using the user interface and the electronic processor to enable the user to tag a selected post for later viewing.

14. The method of claim 8 further comprising:
using the user interface and the electronic processor to enable the user to tag a selected post for later viewing; and
enabling the user to view the tagged selected post on the display screen while the motor vehicle is parked.

15. A motor vehicle infotainment system, comprising:
a loudspeaker;
a microphone;
a touch-sensitive display screen, at least one of the microphone and the touch-sensitive display screen being configured to receive a request from a driver to access a social media web site; and
an electronic processor configured to:
access posts on the social media web site; and
present the posts to the driver exclusively via the loudspeaker.

16. The infotainment system of claim 15 wherein the user interface and the electronic processor are configured to conjointly enable the user to like selected ones of the presented posts.

17. The infotainment system of claim 15 wherein the microphone and the electronic processor are configured to conjointly enable the user to create a post and/or comment on a post.

18. The infotainment system of claim 15 wherein the user interface and the electronic processor are configured to conjointly enable the user to toggle post comments ON and OFF.

19. The infotainment system of claim 15 wherein the user interface and the electronic processor are configured to conjointly enable the user to tag a selected post for later viewing.

20. The infotainment system of claim 15 wherein the user interface and the electronic processor are configured to conjointly enable the user to tag a selected post for later viewing on the display screen while the motor vehicle is parked.
